(19) United States
(12) Patent Application Publication
(10) Pub. No.: US 2007/0065558 A1
(43) Pub. Date: Mar. 22, 2007

(54) Process for creating a thermo-irreversible konjac gel food

(76) Inventor: Yaping Ding, Cupertino, CA (US)

Correspondence Address: WHITE-WELKER & WELKER, LLC, P.O. BOX 199, CLEAR SPRING, MD, 21722-0199, US

(21) Appl. No.: 11/228,984

(22) Filed: Sep. 17, 2005

(51) Int. Cl. A23L 1/05

(52) U.S. Cl. 426/578

(57) ABSTRACT

The present invention is a process for creating a konjac glucomannan based food product. More specifically, the method for transforming konjac glucomannan solutions into heat-stable gels requires the use of heat and a high pH to deacetylate the konjac glucomannan molecule. A minimum concentration of 1.5-2% konjac glucomannan is necessary to adjust the system to a pH of approximately 9.0. When the solution is heated to 85° C. with a mild alkali condition (pH 9-10) it forms a gel which is unaffected by heat. Thus, the gel remains stable when additional heat is applied and remains unchanged under repeated heating at 100° C. or even at 200° C. Alternatively, the addition of an alkali, like Ca(OH)₂ in a konjac glucomannan solution removes its acetyl group forming a stable network structure to form the gel structure. By mixing the konjac glucomannan soluble fiber, with any kind of insoluble fibers and alkalis together, a pure fiber konjac gel food can be made by simply pouring the complex powder into water applying heat. The traditional konjac gel foods texture is hard, chewy and rubbery, the new gel foods in which the insoluble fiber is added improves the texture of the gel foods.

### SEQUENCE LISTING OR PROGRAM

Not Applicable

### FEDERALLY SPONSORED RESEARCH

Not Applicable

### CROSS REFERENCE TO RELATED APPLICATIONS

Not Applicable

### TECHNICAL FIELD OF THE INVENTION

This invention relates to edible materials. More specifically, the present invention relates to thermo-irreversible konjac gel foods.

### BACKGROUND OF THE INVENTION

Konjac gel foods are a traditional Asian food. They are formed when konjac glucomannan soluble fiber is dissolved in alkaline coagulants such as calcium hydroxide, sodium or potassium carbonate. Dissolving konjac glucomannan soluble fiber in alkaline coagulants leads to deacetylation and a thermally stable gel is formed. Gel foods can be made by mixing konjac glucomannan soluble fiber, adding some Alkali, mixing together and putting into water and applying heat.

Konjac gel foods can be very easily made by simply placing konjac glucomannan soluble fiber into water, add Alkali, and heat it to make a konjac gel food. Konjac glucomannan is one kind of heat irreversible gel. If a thermally stable konjac gel is desired, simply deacetylating konjac glucomannan soluble fiber in mild alkali such as a calcium hydroxide solution is all that is required. One major drawback to konjac gel that is formed in this manner is its hard, chewy and rubbery texture. It is therefore an objective of the present invention to teach a process for creating a thermo-irreversible konjac gel food that has an improved texture.

### SUMMARY OF THE INVENTION

The present invention is a process for creating a konjac glucomannan based food product. More specifically, the method for transforming konjac glucomannan solutions into heat-stable gels requires the use of heat and a high pH to deacetylate the konjac glucomannan molecule. A minimum concentration of 1.5-2% konjac glucomannan is necessary to adjust the system to a pH of approximately 9.0. When the solution is heated to 85° C. with a mild alkali condition (pH 9-10) it forms a gel which is unaffected by heat. Thus, the gel remains stable when additional heat is applied and remains unchanged under repeated heating at 100° C. or even at 200° C. Alternatively, the addition of an alkali, like Ca(OH)₂ in a konjac glucomannan solution removes its acetyl group forming a stable network structure to form the gel structure.

One major drawback to konjac gel that is formed in this manner is its hard, chewy and rubbery texture. The present invention improves the konjac gel foods texture by add insoluble fiber such as oat insoluble fiber within the konjac gel foods process, by mixing the insoluble fiber with the konjac glucomannan fiber first, keep the same process.

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced.

These embodiments are described in sufficient detail to enable those skilled in the art to practice the invention, but other embodiments may be utilized and logical, mechanical, electrical, and other changes may be made without departing from the scope of the present invention. The following detailed description is therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention.

Konjac is a polysaccharide and belongs to the family of glucomannan. Konjac glucomannan is made when a tuber or the root of the konjac plant is ground and becomes the natural ingredient used in traditional foods, such as noodles and heat stable gelled food products in Asia for centuries. In water, konjac glucomannan dissolves and forms highly viscous, pseudoplastic solutions. When this viscous solution is exposed to heat and diluted with alkali it transforms konjac into a heat stable gel that remains unaffected by acid and salt also.

Another property of konjac is its high molecular weight. Being a high molecular weight polysaccharide, konjac forms highly viscous solutions when it is dispersed in water and when it is treated with mild alkali arid heat, konjac solutions set-up into heat-stable gels. This ability to form gels is because of the process of deacetylation. Deacetylation occurs with alkali and gives konjac the ability to function in this unique dual capacity. A mild alkali added to the solution leads to the formation of a heat-stable gel that is resistant to melting, even under extended heating conditions.

A heat-stable gel can be formed with any of the following mild or dilute alkalis:

Potassium hydroxide (KOH)
Sodium hydroxide (NaOH)
Calcium hydroxide (CaOH)2 (picking lime)
Potassium carbonate (K₂CO₃)
Calcium oxide (CaO) Lime

A simple heat stable gel can be made by using 1 tablespoon of konjac glucomannan and ¼ teaspoon of pickling lime (a food grade calcium hydroxide) or ¼ teaspoon baking soda. In the first step, 2 cups of water are placed into a pot. Then in a second step, konjac glucomannan powder and pick lime (calcium hydroxide (CaOH)2) are mixed together. Then, in the third step, the complex powder is added into the water, stirring continuously to a boil. In a final, fourth step, the mixture is boiled for about 3 minutes and then remove from heat. The result is a thermally stable (non-reversible) gel when the mixture cools down. The gel is then cut into small pieces, dipped in water or steam for about 3-5 minutes and the konjac gel foods are formed.

In an alternative embodiment, konjac glucomannan soluble fiber, an insoluble fiber such as oat fiber, and picking lime powder (Food grade calcium hydroxide) are mixed together, and then stirred into water to form the solution. The solution is then heated so that it can become a konjac gel food.

A more specific process includes 1-tablespoon konjac powder, 1 tablespoon oak fiber, ⅛ teaspoon pickling lime, mixed as a complex powder. Next, 3 cups of cold water is poured into a pot. Two tablespoons of complex powder are stirring continuously to a boil. The mixture is boiled for about 4 minutes and then removed from the heat. A thermally stable (non-reversible) gel is formed once the mixture cools down or it can be made by microwaving 1 tablespoon konjac powder, 1 tablespoon oak fiber, ⅛ tea spoon pickling lime, mixed as complex powder where 3 cups of cold water are poured into a microwaveable glass dish. Next, 2 tablespoons complex powder are stirred in and the microwave is used to heat the solution for about 10 minutes. After heating, the mixture is removed from the microwave and a thermally stable (non-reversible) gel is formed once the mixture cools down.

The outstanding feature of konjac glucomannan fiber is its unique jelling ability. The method to form an elastic, solid and irreversible gel involves putting a little alkali into 2%-3% konjac solution, heating it to 85 degrees and leaving it alone for two hours. The gel formed in this manner has unparalleled high thermo-stability; it does not melt even under prolonged heating. A variety of foods can be made, such as konjac cake, konjac noodle, animal food-imitating food, vegetarian food, and many other things by using the thermo-irreversible property of konjac glucomannan fiber.

In order to set konjac glucomannan solutions into heat-stable gels heat and a high pH must be used to deacetylate the konjac glucomannan molecule. To make effective gels a minimum concentration of 1.5-2% konjac glucomannan is required and pH of the system must be approximately 9.0. The pH of the gel is quickly neutralized in a food system.

Konjac glucomannan is easily dispersed in hot or cold water and it forms a highly viscous solution with a pH between 4.0 and 7.0. With heat and mechanical agitation its solubility can be accelerated. By adding a mild alkali to the solution it forms a heat-stable gel that does not melt, even under extended heating conditions.

The konjac glucomannan loses acetyl groups and forms a gel after heating and alkali treatment. In other words, heat-stable gels form in konjac glucomannan when it is set with alkali and heat. In short, konjac glucomannan can form an elastic, thermo-irreversible gel when it is added to an alkaline solution and heat-stable konjac gels form when it is set with alkali and heat. The gels are acid and salt stable.

The reason why konjac solution does not form gel is because its acetyl group does not allow the long chains of glucomannan to come close to each other. However, when it is heated to 85° C. with mild alkali condition (pH 9-10) it does form gel. The gel formed is unaffected by heat and remains stable to heat and unchanged under repeated heating at 100° C. or even at 200° C. This special quality of the gel has proved to be of great value especially for making several healthy and slim foods in Asian countries, such as konjac cakes, noodles, chips, imitating dishes for vegetarians (vegetarian shrimps, hams and steaks), bread, cookies, edible films, a fat substitute in hams, sausages, meatballs and many more.

Moreover, a mild alkali like calcium hydroxide is added to the konjac glucomannan solution it will set to a strong, elastic gel that will not melt even when heated for a long period of time. Alternatively, if an alkali, like Ca (OH) 2 is added to a konjac glucomannan solution the acetyl group can be removed, forming a stable network structure to form the gels.

It is important to know that konjac glucomannan solution does not form gel because its acetyl group does not allow the long chains of glucomannan to approach each other. However, it does form gel when it is heated at a pH of 9-10. This gel resists heat and remains stable under repeated heating at 100 degrees or even at 200 degrees. Nevertheless, when the environment is mildly alkaline, konjac solution forms thermo-irreversible gel after cooling from hot solution.

This explains why this gel is called non-reversible gel. Its mechanism involves the process whereby the acetyl deviates from glucomannan in a naked state when heated under an alkali condition and forms partial structural crystallization due to the occurrence of hydrogen bonds between molecules. This helps konjac glucomannan to become stable because of the formation of a net-like structure that has crystals as nodes. Various kinds of foods can b e made, such as konjac cake, konjac chips, konjac slices, konjac noodles, and also imitating foods for vegetarians by using the heat non-reversible property of the konjac glucomannan.

It is appreciated that the relationships for the parts of the invention, to include variation in database and subsystem configuration to detach them for each other and provide the possibilities to deploy the system in different locations and under different authorities with division of labor, are deemed readily apparent and obvious to one of ordinary skill in the art, and all equivalent relationships in the above description are intended to be encompassed by the present invention.

In addition, other areas of art may benefit from this method and adjustments to the design are anticipated. Thus, the scope of the invention should be determined by the appended claims and their legal equivalents, rather than by the examples given.

1. A process for creating a konjac glucomannan based food product wherein a complex powder that contains konjac glucomannan soluble fiber, insoluble fiber, and alkalis is made by mixing konjac glucomannan soluble fiber powder, any kind insoluble fiber and alkalis and then applying heat and allowing it to cool to become gel foods.

2. The process for creating a konjac glucomannan based food product of claim 1 wherein within the complex powder, the ratio of alkalis to konjac glucomannan soluble fiber is at least 2%.

3. The process for creating a konjac glucomannan based food product of claim 1 wherein within the complex powder, the ratio of konjac glucomannan soluble fiber to insoluble fiber can be within a range of 10:1 through 1:10.

4. The process for creating a konjac glucomannan based food product of claim 1 wherein within the complex powder, the alkalis can be any one of following: calcium hydroxide (CaOH)2, calcium oxide (CaO), potassium hydroxide (KOH), sodium hydroxide (NaOH), or potassium carbonate (K2CO3).

5. The process for creating a konjac glucomannan based food product of claim 1 wherein within the complex powder, the alkali can be calcium hydroxide (CaOH)2.

6. The process for creating a konjac glucomannan based food product of claim 1 wherein the insoluble fiber within the complex powder can be any one of following insoluble fibers: wheat insoluble fiber, oat insoluble fiber, apple insoluble fiber, orange insoluble fiber, tomato insoluble fiber, bamboo insoluble fiber, cottonseed insoluble fiber, soy insoluble fiber, potato insoluble fiber, or cellulose insoluble fiber.

7. The process for creating a konjac glucomannan based food product of claim 1 wherein the ratio of complex powder to water is at least 1.5%.

8. The process for creating a konjac glucomannan based food product of claim 7 wherein:
the complex powder is comprised of one tablespoon konjac powder, one tablespoon oak fiber, and ⅛ teaspoon pickling lime, mixed as a complex powder;
three cups of cold water are poured into a pot; two tablespoons of complex powder are stirring continuously to a boil;
the mixture is boiled for 4 minutes and then removed from the heat;
a thermally stable non-reversible gel is formed once the mixture cools.

9. The process for creating a konjac glucomannan based food product of claim 8 wherein said product is made by microwaving said complex powder.

10. The process for creating a konjac glucomannan based food product of claim 1 wherein an alkali is added into a minimum 2% konjac solution, heating the solution to 85 degrees and leaving it alone for two hours yields a gel with has unparalleled high thermo-stability that will not melt even under prolonged heating.

11. The process for creating a konjac glucomannan based food product of claim 10 wherein the concentration of konjac glucomannan is at least 2% and the pH of the system is 9.0.

12. A konjac glucomannan based food product wherein a complex powder comprises konjac glucomannan soluble fiber, insoluble fiber, and an alkali compound.

13. The konjac glucomannan based food product of claim 12 wherein within the complex powder, the ratio of alkalis to konjac glucomannan soluble fiber is at least 2%.

14. The konjac glucomannan based food product of claim 12 wherein within the complex powder, the ratio of konjac glucomannan soluble fiber to insoluble fiber can be within a range of 10:1 through 1:10.

15. The konjac glucomannan based food product of claim 12 wherein, within the complex powder, the alkalis can be any one of following: calcium hydroxide (CaOH)2, calcium oxide (CaO), potassium hydroxide (KOH), sodium hydroxide (NaOH), or potassium carbonate (K2CO3).

16. The konjac glucomannan based food product of claim 12 wherein the insoluble fiber within the complex powder can be any one of following insoluble fibers: wheat insoluble fiber, oat insoluble fiber, apple insoluble fiber, orange insoluble fiber, tomato insoluble fiber, bamboo insoluble fiber, cottonseed insoluble fiber, soy insoluble fiber, potato insoluble fiber, or cellulose insoluble fiber.
